(19) United States
(12) Patent Application Publication
(10) Pub. No.: US 2023/0350010 A1
(43) Pub. Date: Nov. 2, 2023

(54) LIDAR DEVICE AND RANGING ADJUSTMENT METHOD OF THE SAME

(71) Applicant: SUTENG INNOVATION TECHNOLOGY CO., LTD., Shenzhen (CN)

(72) Inventor: Changsheng GONG, Shenzhen (CN)

(73) Assignee: SUTENG INNOVATION TECHNOLOGY CO., LTD., Shenzhen (CN)

(21) Appl. No.: 18/136,322

(22) Filed: Apr. 18, 2023

(30) Foreign Application Priority Data
Apr. 29, 2022 (CN) 202210467360.7

(51) Int. Cl. G01S 7/295; G01S 7/52

(52) U.S. Cl. CPC G01S 7/295; G01S 7/52025

(57) ABSTRACT

The present disclosure provides a LiDAR device and a ranging adjustment method of the same. The ranging adjustment method includes: turning off a laser beam emission module and turning on a laser beam receiving module, to obtain histogram data of ambient light; adjusting detection efficiency of the laser beam receiving module based on the histogram data of the ambient light; turning on the laser beam emission module and the laser beam receiving module, to obtain histogram data of a current optical signal; and comparing the histogram data of the current optical signal with the histogram data of the ambient light, and determining histogram data of an echo signal and distance information of a to-be-detected object, based on a result of the comparison.

### CROSS-REFERENCE TO RELATED APPLICATION

The present application claims the benefit of priority to Chinese Patent Application No. 202210467360.7, filed on Apr. 29, 2022, which is hereby incorporated by reference in its entirely.

### TECHNICAL FIELD

The present disclosure pertains to the technical field of LiDAR, and in particular, to a LiDAR device and a ranging adjustment method.

### BACKGROUND

With continuous development of fields of artificial intelligence and autonomous driving, increasingly high requirements are also imposed on detection accuracy and detection distance of a LiDAR.

The detection accuracy and detection distance of the LiDAR device depend on both a feature of a to-be-detected object and light in an environment in which the LiDAR device is located.

For example, when there is intense sunlight, a laser beam receiving device of the laser beam receiving module, for example, a photoelectric detection avalanche diode, is prone to saturation. When an echo signal is received in such environment, due to saturation and dead time of such photoelectric receiving device, no echo signal can be received from a target object, and actual distance information cannot be accurately detected, thereby decreasing ranging accuracy of the LiDAR.

### SUMMARY

The present disclosure aims to provide a ranging adjustment method of a LiDAR device, to resolve a problem that ranging accuracy is decreased because a conventional LiDAR device is apt to be affected by ambient light.

A first aspect of the embodiments of the present disclosure provides a ranging adjustment method of a LiDAR device, where the LiDAR device includes a laser beam emission module and a laser beam receiving module, where the ranging adjustment method of a LiDAR device includes steps of: turning off a laser beam emission module and turning on a laser beam receiving module to obtain histogram data of ambient light; adjusting detection efficiency of the laser beam receiving module based on the histogram data of the ambient light; turning on the laser beam emission module and the laser beam receiving module to obtain histogram data of a current optical signal; and comparing the histogram data of the current optical signal with the histogram data of the ambient light, and determining histogram data of an echo signal and distance information of a to-be-detected object based on magnitude of a ratio or magnitude of a difference.

In some embodiments, the ranging adjustment method of a LiDAR device further includes:
adjusting the detection efficiency of the laser beam receiving module based on the histogram data of the ambient light, and correspondingly adjusting emission power and/or a number of laser beam emissions of the laser beam emission module in one frame of scanning image; or
after the distance information of the to-be-detected object is determined, correspondingly adjusting emission power and/or a number of laser beam emissions of the laser beam emission module in one frame of scanning image based on the histogram data of the echo signal.

In some embodiments, steps of obtaining histogram data of ambient light include:
turning off a laser beam emission module and turning on a laser beam receiving module to receive current ambient light; and converting ambient light received multiple times into multiple corresponding pulse signals, and superimposing the multiple corresponding pulse signals to form the histogram data of the ambient light.

In some embodiments, steps of converting ambient light received multiple times into multiple corresponding pulse signals and superimposing the multiple corresponding pulse signals to form the histogram data of the ambient light include: performing averaging processing on the multiple pulse signals converted from the ambient light received multiple times, generating multiple pulse signals with equal amplitude, and superimposing the multiple pulse signals to form the histogram data of the ambient light.

In some embodiments, steps of adjusting the detection efficiency of the laser beam receiving module based on the histogram data of the ambient light and adjusting emission power and/or a number of laser beam emissions of the laser beam emission module in one frame of scanning image include: when the histogram data of the ambient light is greater than a first preset threshold of the histogram data, reducing the detection efficiency of the laser beam receiving module, and increasing the emission power and/or the number of laser beam emissions of the laser beam emission module in the frame of scanning image; when the histogram data of the ambient light is less than a first preset threshold of the histogram data, increasing the detection efficiency of the laser beam receiving module, and reducing the emission power and/or the number of laser beam emissions of the laser beam emission module in the frame of scanning image; or when the histogram data of the ambient light is within a first preset range of the histogram data, setting the detection efficiency of the laser beam receiving module to constant preset detection efficiency, and setting the emission power and/or the number of laser beam emissions of the laser beam emission module in the frame of scanning image to constant power and/or a constant number of emissions.

In sonic embodiments, after the distance information of the to-be-detected object is determined, steps of correspondingly adjusting emission power and/or a number of laser beam emissions of the laser beam emission module in one frame of scanning image based on the histogram data of the echo signal include: when the histogram data of the echo signal is greater than a second preset threshold of the histogram data, reducing the emission power and/or the number of laser beam emissions of the laser beam emission module in the frame of scanning image; when the histogram data of the echo signal is less than a second preset threshold of the histogram data, increasing the emission power and/or the number of laser beam emissions of the laser beam emission module in the frame of scanning image; or when the histogram data of the echo signal is within a second preset range of the histogram data, setting the emission power and/or the number of laser beam emissions of the laser beam emission module in the frame of scanning image to constant power and/or a constant number of emissions.

A second aspect of the embodiments of the present disclosure provides a LiDAR device, including a laser beam emission module, a laser beam receiving module, and a control circuit respectively connected to the laser beam emission module and the laser beam receiving module, where the control circuit includes a memory, a processor, and a computer program stored in the memory and capable of running on the processor, where when the processor executes the computer program, steps of the foregoing ranging adjustment method of a LiDAR device are implemented.

In some embodiments, the laser beam emission module includes: a laser beam emission assembly; and a laser beam drive circuit respectively connected to the control circuit and the laser beam emission assembly, where the laser beam drive circuit is correspondingly turned on or off based on a control signal output by the control circuit, and correspondingly adjusts emission power and/or a number of laser beam emissions of the laser beam emission module in one frame of scanning image, where the laser beam emission assembly includes multiple lasers.

In some embodiments, the laser beam receiving module includes: a laser beam receiving assembly, where the laser beam receiving assembly is configured to convert a corresponding optical signal into a current signal; a power supply circuit respectively connected to the control circuit and the laser beam receiving assembly, where the power supply circuit is triggered by a control signal of the control circuit to output a voltage signal with a corresponding value to the laser beam receiving assembly, to adjust detection efficiency of the laser beam receiving assembly; and a signal processing circuit respectively connected to the laser beam receiving assembly and the control circuit, where the signal processing circuit is configured to: convert, into corresponding histogram data, an electrical signal converted and output by the laser beam receiving assembly, and output the corresponding histogram data to the control circuit, where the laser beam receiving assembly includes a photoelectric converter.

In some embodiments, the photoelectric converter includes a photoelectric detection avalanche diode.

The embodiments of the present disclosure have effects: in the foregoing ranging adjustment method of the LiDAR device, the histogram data of the ambient light is first obtained, the detection efficiency of the laser beam receiving module is adjusted based on the histogram data, to implement dynamic adjustment, then the optical signal including the ambient light and the echo signal and the corresponding histogram data are obtained for comparison, to determine the histogram data of the current echo signal and the distance information of the to-be-detected object, and the detection efficiency of the laser beam receiving module is adjusted to reduce impact of the ambient light in a laser beam ranging process and improve the ranging accuracy.

### BRIEF DESCRIPTION OF DRAWINGS

Exemplary embodiments of this application are described with reference to the accompanying drawings, to illustrate the objectives, features, and advantages of this application. In the exemplary embodiments of this application, the same reference numerals represent the same components.

FIG. l is a first schematic structural diagram of a LiDAR device according to an embodiment of the present disclosure;

FIG. 2 is a first flowchart of a ranging adjustment method of a LiDAR device according to an embodiment of the present disclosure;

FIG. 3 is a histogram of a ranging adjustment method of a LiDAR device according to an embodiment of the present disclosure;

FIG. 4 is a second flowchart of a ranging adjustment method of a LiDAR device according to an embodiment of the present disclosure;

FIG. 5 is a third flowchart of a ranging adjustment method of a LiDAR device according to an embodiment of the present disclosure;

FIG. 6 is a flowchart of step S10 of a ranging adjustment method of a LiDAR device shown in FIG. 2;

FIG. 7 is a flowchart of step S50 of a ranging adjustment method of a LiDAR device shown in FIG. 4;

FIG. 8 is a flowchart of step S60 in a ranging adjustment method of a LiDAR device shown in FIG. 6;

FIG. 9 is a schematic sequence diagram of a ranging adjustment method of a LiDAR device according to an embodiment of the present disclosure;

FIG. 10 is a second schematic structural diagram of a LiDAR device according to an embodiment of the present disclosure;

FIG. 11 is a third schematic structural diagram of a LiDAR device according to an embodiment of the present disclosure; and

FIG. 12 is a fourth schematic structural diagram of a LiDAR device according to an embodiment of the present disclosure.

### DETAILED DESCRIPTION

For the purpose of illustration rather than limitation, the following describes details such as a system structure and technology, to facilitate a thorough understanding of the embodiments of this application.

It should be understood that when used in this specification and appended claims, a term “include” indicates existence of a described feature, integrity, a step, an operation, an element, and/or a component, but does not exclude existence or addition of one or more other features, integrity, steps, operations, elements, components, and/or a collection thereof.

It should also be understood that the terms used in this specification of this application are only used to describe the embodiments and are not intended to limit this application. As used in this specification and the appended claims of this application, unless otherwise the context clearly indicates another case, singular forms of “a,” “an,” and “the” are intended to include plural forms.

In addition, in the description of the present application, the terms such as “first” and “second” are merely intended for the purpose of description, and shall not be understood as an indication or implication of relative importance.

A first aspect of the embodiments of the present disclosure provides a ranging adjustment method of a LiDAR device 1. As shown in FIG. 1, a LiDAR device 1 includes a laser beam emission module 10 and a laser beam receiving module 20. The laser beam emission module 10 includes a laser beam emission assembly 11 and a corresponding drive circuit, and the drive circuit is controlled to drive the laser beam emission assembly 11 to emit a laser beam signal. The laser beam receiving module 20 includes a corresponding laser beam receiving assembly 21 and a corresponding signal processing circuit 23. The laser beam receiving assembly 21 is configured to receive ambient light Light1 and/or an echo signal Light2 reflected by a to-be-detected object 2, convert the echo signal Light2 into a current signal and send the current signal to the signal processing circuit 23, and the signal processing circuit 23 converts the current signal into a corresponding pulse signal.

The ambient light Light1 includes sunlight, light emitted by a luminous object, and the like. In order to ensure sufficient sensitivity of the LiDAR device 1, the laser beam receiving assembly 21 in the laser beam receiving module 20 adaptively changes a gain along with intensity of light, which is prone to a problem that the converted electrical signal is excessively small due to saturation or an excessively small gain. For example, when a detector adaptively changes to a high gain in an environment with intense ambient light Light1, the detector is saturated, and cannot receive an echo signal Light2 from a target object or accurately detect actual distance information, thereby decreasing ranging accuracy of the LiDAR.

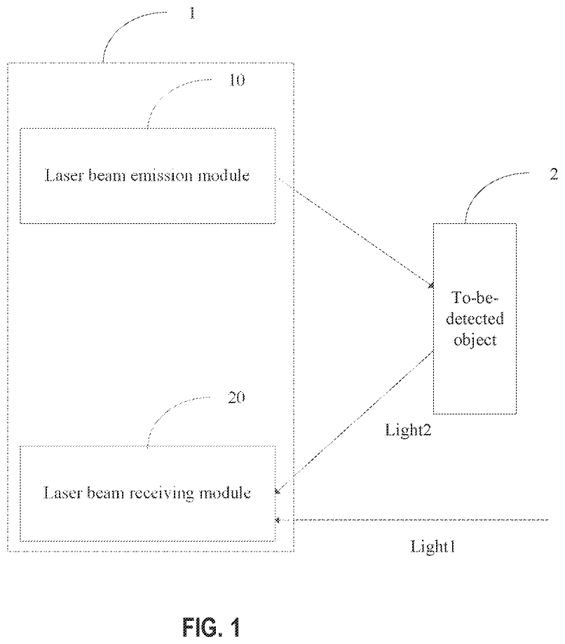

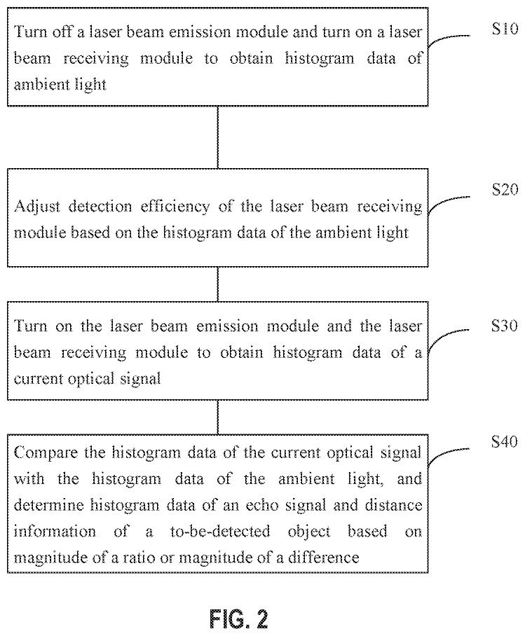

To resolve this problem, a ranging adjustment method of a LiDAR device 1 is proposed, and as shown in FIG. 2, the method includes the following steps:

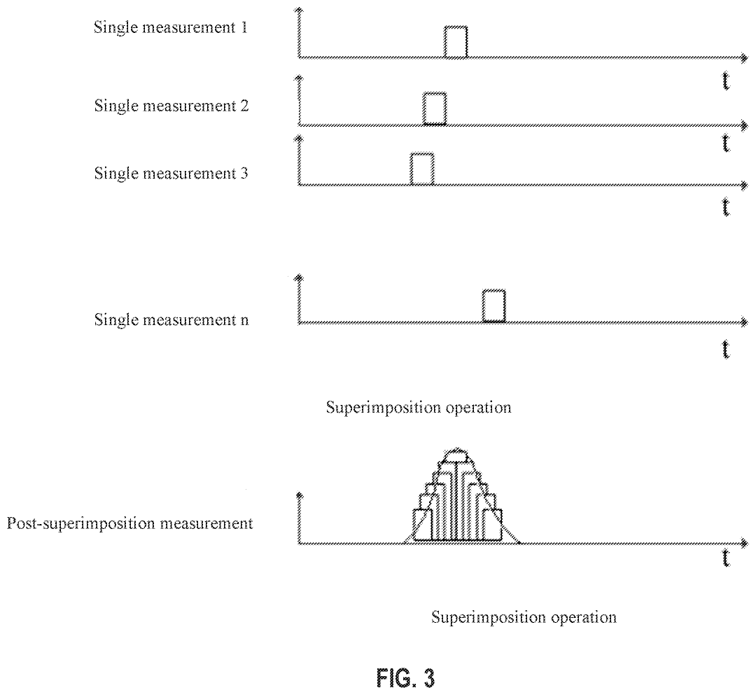

Step S10: Turn off a laser beam emission module 10 and turn on a laser beam receiving module 20 to obtain histogram data of ambient light Light1. The laser beam receiving module 20 works alone and receives the current ambient light Light1, performs photoelectric conversion and signal processing, and converts and outputs a corresponding pulse signal. The histogram data refers to a histogram formed by superposing multiple converted and output pulse signals in a time sequence. As shown in FIG. 3, multiple measured pulse signals form histogram data with a variable time sequence and amplitude. Histogram data of the ambient light Light1 is a random noise waveform.

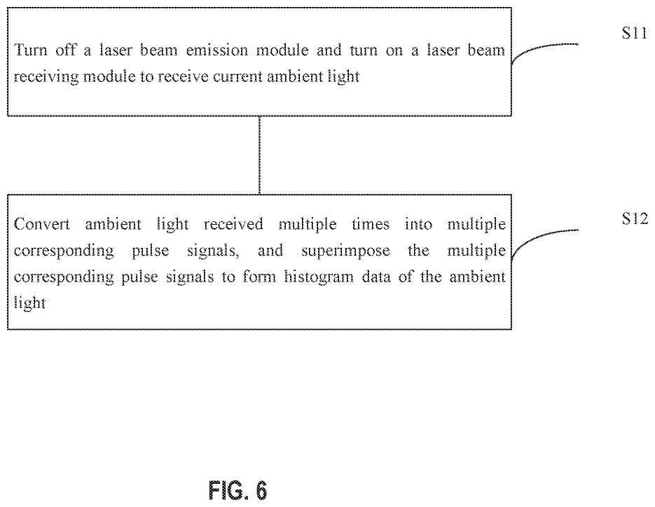

Herein, in order to obtain the histogram data of the ambient light Light1 while improving the detection accuracy, in some embodiments, as shown in FIG. 6, steps of obtaining histogram data of ambient light Light1 include:

Step S11: Turn off a laser beam emission module 10 and turn on a laser beam receiving module 20 to receive current ambient light Light1.

Step S12: In a manner of obtaining a histogram, convert ambient light Light1 received multiple times into multiple corresponding pulse signals, and superimpose the multiple corresponding pulse signals to form histogram data of the ambient light Light1.

In addition, in order to improve the detection accuracy and avoid a histogram data error caused by problems of missed reception and erroneous reception, in some embodiments, steps of converting ambient light Light1 received multiple times into multiple corresponding pulse signals, and superimposing the multiple corresponding pulse signals to form histogram data of the ambient light Light1 include:

performing averaging processing on the multiple pulse signals converted from the ambient light Light1 received multiple times, generating multiple pulse signals with equal amplitude, and superimposing the multiple pulse signals to form the histogram data of the ambient light Light1. The histogram data includes multiple pulse signals that change in a preset phase sequence and have equal amplitude, to implement averaging processing multiple times and improve accuracy of the histogram data of the ambient light Light1.

Step S20: Adjust detection efficiency of the laser beam receiving module 20 based on the histogram data of the ambient light Light1.

Herein, the Photon Detection Efficiency refers to a ratio of a number of photons detected by the laser beam receiving assembly 21 (for example, a silicon photomultiplier tube or a photoelectric detection avalanche diode 211) to a number of incident photons, that is, efficiency of converting the optical signal into the electrical signal by the laser beam receiving assembly 21. The higher the detection efficiency, the stronger the sensitivity of the laser beam receiving module 20 to photons; and the lower the detection efficiency, the lower the sensitivity of the laser beam receiving module 20 to photons.

Herein, when the histogram data of the ambient light Light1 is obtained, intensity of the current ambient light Light1 can be determined. When an excessively small electrical signal is converted and output due to oversaturation or an excessively small gain caused by an excessively large gain of the laser beam receiving assembly 21, the detection efficiency of the laser beam emission module 10 is adjusted based on the intensity of the ambient light Light1. That is, when intense ambient light Light1 is detected, the detection efficiency of the laser beam receiving assembly 21 is reduced, to reduce the sensitivity of the laser beam receiving assembly 21 and avoid oversaturation caused by the excessively large gain of the laser beam receiving assembly 21. In addition, when weak ambient light Light1 is detected, the detection efficiency of the laser beam receiving assembly 21 is improved, to improve the sensitivity and gain of the laser beam receiving assembly 21, thereby ensuring that the laser beam receiving assembly 21 reliably receives the current ambient light Light1 and an echo signal Light2.

Herein, detection efficiency of the laser beam receiving assembly 21 is related to a working voltage of the laser beam receiving assembly 21, and therefore, the detection efficiency of the laser beam receiving assembly 21 can be adjusted by adjusting the working voltage of the laser beam receiving assembly 21.

Step S30: Turn on the laser beam emission module 10 and the laser beam receiving module 20 to obtain histogram data of a current optical signal.

Step S40: Compare the histogram data of the current optical signal with the histogram data of the ambient light Light1, and determine histogram data of an echo signal Light2 and distance information of a to-be-detected object 2 based on magnitude of a ratio or magnitude of a difference.

When the detection efficiency of the laser beam receiving module 20 is set to a corresponding value, the LiDAR device 1 initiates a ranging function, simultaneously turns on the laser beam emission module 10 and the laser beam receiving module 20, obtains the ambient light Light1 and the reflected echo signal Light2, and obtains histogram data of multiple measured total optical signals. In addition, in order to obtain the histogram data of the echo signal Light2, histogram data of the current optical signal is further compared with histogram data of initially obtained ambient light Light1 through, for example, division calculation or subtraction calculation, and the histogram data of the echo signal Light2 is determined based on the ratio obtained via comparison, that is, a signal-to-noise ratio, or the histogram data of the echo signal Light2 is directly determined based on magnitude of the difference, to obtain amplitude and receiving time of the echo signal Light2 and determine distance information of the to-be-detected object 2 based on the amplitude and the receiving time of the echo signal Light2.

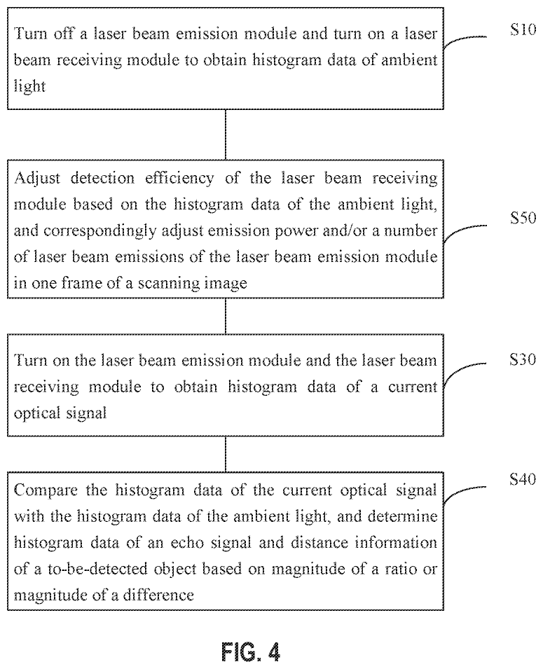

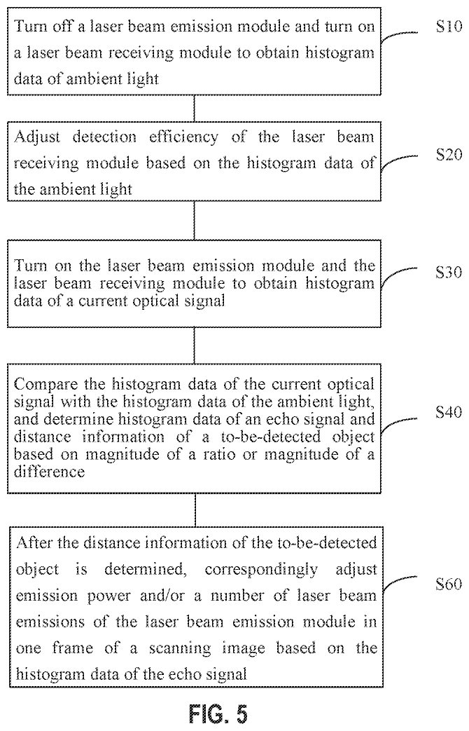

Herein, because the ranging performance of the LiDAR device 1 varies with the detection efficiency, in order to ensure the ranging performance, as shown in FIG. 4 and FIG. 5, the ranging adjustment method of the LiDAR device 1 further includes: adjusting the detection efficiency of the laser beam receiving module 20 based on the histogram data of the ambient light, and correspondingly adjusting emission power and/or a number of laser beam emissions of the laser beam emission module 10 in one frame of scanning image; or after the distance information of the to-be-detected object is determined, correspondingly adjusting emission power and/or a number of laser beam emissions of the laser beam emission module 10 in one frame of scanning image based on the histogram data of the echo signal Light2.

In some embodiments, when to-be-adjusted detection efficiency is determined, the emission power and/or the number of laser beam emissions of the laser beam emission module 10 in the frame of scanning image can be correspondingly adjusted, or ranging is performed through the adjusted detection efficiency. Then the emission power and/or the number of laser beam emissions of the laser beam emission module 10 in the next frame is adjusted based on the ranging information, thereby improving ranging capability for the current frame of scanning image or the next frame of scanning image. Herein, the number of laser beam emissions in the frame of scanning image is increased, that is, the number of superimposition times of the histogram data is increased, to improve a signal-to-noise ratio of a signal and improve the ranging capability. The emission power is increased to increase intensity of the echo signal Light2, thereby improving the ranging capability. One of the two methods can be selected or adjustment is performed separately as per time sequence.

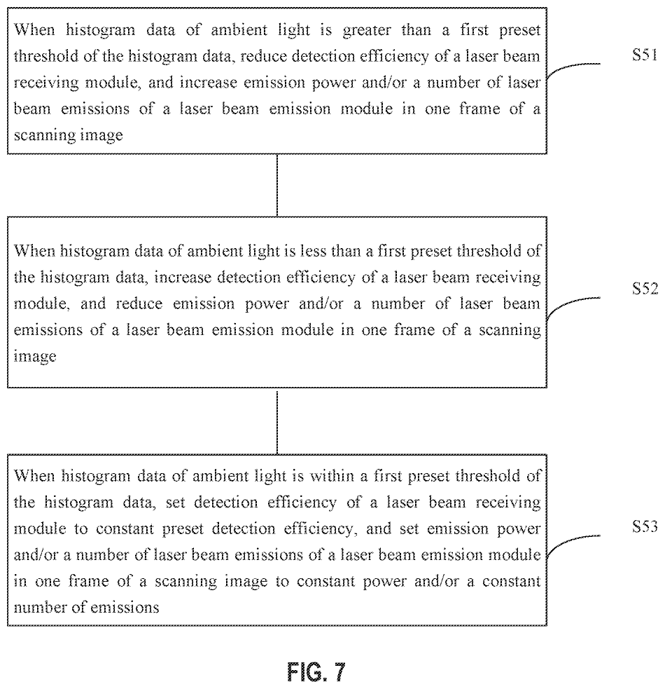

In some embodiments, as shown in FIG. 7, when the detection efficiency and the emission power and/or the number of laser beam emissions of the laser beam emission module 10 in the frame of scanning image are adjusted, steps include:

Step S51: When histogram data of ambient light is greater than a first preset threshold of the histogram data, reduce detection efficiency of a laser beam receiving module 20, and increase emission power and/or a number of laser beam emissions of a laser beam emission module 10 in one frame of scanning image.

Step S52: When histogram data of ambient light is less than a first preset threshold of the histogram data, increase detection efficiency of a laser beam receiving module 20, and reduce emission power and/or a number of laser beam emissions of a laser beam emission module 10 in one frame of scanning image.

Step S53: When histogram data of ambient light is within a first preset range of the histogram data, set detection efficiency of a laser beam receiving module 20 to constant preset detection efficiency, and set emission power and/or a number of laser beam emissions of a laser beam emission module 10 in one frame of scanning image to constant power and/or a constant number of emissions.

Herein, the set value of the emission power and the number of laser beam emissions may be data simulated in advance based on a design requirement or may be data actually calibrated based on the design requirement. This is not limited in this application.

In some embodiments, a first preset threshold of the histogram data corresponds to preset detection efficiency of the laser beam receiving assembly 21. When the detection efficiency exceeds the preset detection efficiency, a gain of the laser beam receiving assembly 21 is excessively large or small, which causes an excessively small saturated or converted electrical signal. Therefore, when it is detected that the histogram data of the ambient light Light1 exceeds the first preset threshold of the histogram data, this indicates that the current ambient light Light1 is excessively intense, which is prone to saturation of the laser beam receiving assembly 21. At this time, the detection efficiency of the laser beam receiving assembly 21 of the laser beam receiving module 20 is decreased. At the same time, in order to avoid a decrease in the ranging capability caused by the decrease in the detection efficiency, the emission power and/or the number of laser beam emissions of the laser beam emission module 10 in the frame of scanning image is correspondingly increased, thereby improving the ranging capability.

In addition, when it is detected that the histogram data of the ambient light Light1 is less than the first preset threshold of the histogram data, this indicates that the current ambient light Light1 is week, which is prone to an excessively small gain of the laser beam receiving assembly 21. At this time, the detection efficiency of the laser beam receiving assembly 21 of the laser beam receiving module 20 is increased. At the same time, in order to match a change in the detection efficiency and avoid the decrease in the ranging capability due to the excessively great emission power or the excessively great number of laser beam emissions in the frame of scanning image, the emission power and/or the number of laser beam emissions of the laser beam emission module 10 in the frame of scanning image is correspondingly decreased, thereby improving the ranging capability.

In addition, when it is detected that the histogram data of the ambient light Light1 is within the first preset range of the histogram data, this indicates that the current ambient light Light1 is normal. At this time, the detection efficiency of the laser beam receiving assembly 21 of the laser beam receiving module 20 is set to constant preset detection efficiency. At the same time, in order to match a change in the detection efficiency and avoid the decrease in the ranging capability due to the excessively great or small emission power or the excessively great or small number of laser beam emissions in the frame of scanning image, the emission power and/or the number of laser beam emissions of the laser beam emission module 10 in the frame of scanning image is set to a constant preset value, thereby improving the ranging capability.

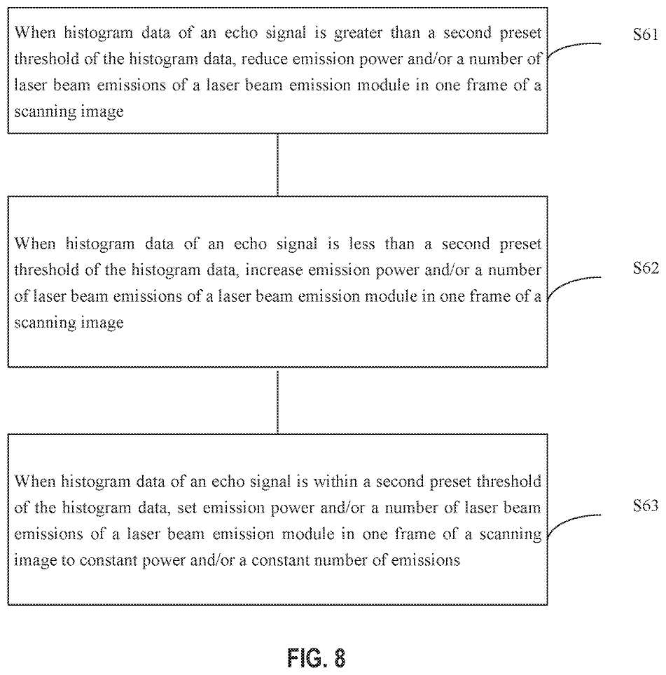

In some embodiments, as shown in FIG. 8, after the distance information of the to-be-detected object is determined, steps of correspondingly adjusting emission power and/or a number of laser beam emissions of the laser beam emission module 10 in one frame of scanning image based on the histogram data of the echo signal Light2 include:

Step S61: When histogram data of an echo signal Light2 is greater than a second preset threshold of the histogram data, reduce emission power and/or a number of laser beam emissions of a laser beam emission module 10 in one frame of scanning image.

Step S62: When histogram data of an echo signal Light2 is less than a second preset threshold of the histogram data, increase emission power and/or a number of laser beam emissions of a laser beam emission module 10 in one frame of scanning image.

Step S63: When histogram data of an echo signal Light2 is within a second preset range of the histogram data, set emission power and/or a number of laser beam emissions of a laser beam emission module 10 in one frame of scanning image to constant power and/or a constant number of emissions.

In some embodiments, when it is detected that histogram data of an echo signal Light2 obtained in a previous frame is greater than the second preset threshold of the histogram data, this indicates that in a previous frame of scanning image, adjusted detection efficiency of the laser beam receiving module 20 is excessively high, the determined histogram data of the echo signal Light2 is eventually increased, and accuracy of the ranging information is reduced. At this time, in order to obtain accurate histogram data of the echo signal Light2 and improve a ranging capability for the next frame of scanning image, a number of laser beam emissions and/or emission power in the next frame of scanning image is correspondingly reduced, so that amplitude of the echo signal Light2 in the next frame of scanning image is within the preset range.

Similarly, when it is detected that histogram data of an echo signal Light2 obtained in a previous frame is less than the second preset threshold of the histogram data, this indicates that in a previous frame of scanning image, adjusted detection efficiency of the laser beam receiving module 20 is excessively low, the determined histogram data of the echo signal Light2 is eventually decreased, and accuracy of the ranging information is reduced. At this time, in order to obtain accurate histogram data of the echo signal Light2 and improve a ranging capability for the next frame of scanning image, a number of laser beam emissions and/or emission power in the next frame of scanning image is correspondingly increased, so that amplitude of the echo signal Light2 in the next frame of scanning image is within the preset range.

In addition, when it is detected that histogram data of an echo signal Light2 obtained in a previous frame is within the second preset range of the histogram data, this indicates that in a previous frame of scanning image, adjusted detection efficiency of the laser beam receiving module 20 is within a reasonable range. At this time, a number of laser beam emissions and/or emission power in the next frame of scanning image is maintained at a constant number of emissions or constant power, thereby improving the ranging capability.

Herein, the first preset threshold and the second preset threshold of the histogram data can be correspondingly set based on the histogram data corresponding to the ambient light and the echo signal Light2, and obtained through auto-learning or multiple detections, and are not limited to a specific value.

The embodiments of the present disclosure have following effects: In the foregoing ranging adjustment method of the LiDAR device 1, the histogram data of the ambient light Light1 is first obtained, the detection efficiency of the laser beam receiving module 20 is adjusted based on the histogram data, to implement dynamic adjustment, then the optical signal including the ambient light Light1 and the echo signal Light2 and the corresponding histogram data are obtained for comparison, to determine the histogram data of the current echo signal Light2 and the distance information of the to-be-detected object 2, and the detection efficiency of the laser beam receiving module 20 is adjusted to reduce impact of the ambient light Light1 in a laser beam ranging process and improve the ranging accuracy.

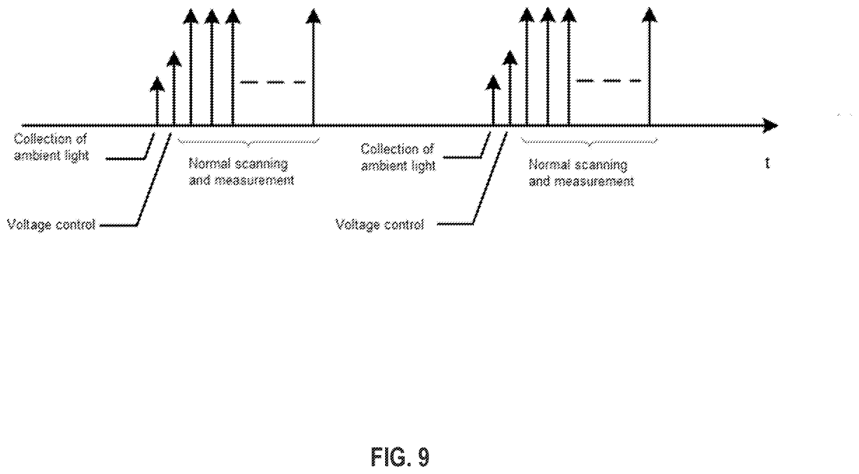

In some embodiments, the ranging adjustment method of a LiDAR device 1 further includes: repeating the foregoing steps of the ranging adjustment method of the LiDAR device 1 at preset time intervals, that is, as shown in FIG. 9, steps of obtaining the histogram of the ambient light Light1 based on the preset frequency, adjusting the detection efficiency of the laser beam receiving module 20, adjusting the emission power and/or the number of laser beam emissions of the laser beam emission module 10 in the frame of scanning image, determining the amplitude and the receiving time of the echo signal Light2 based on the current optical signal, and finally determining the distance information of the to-be-detected object 2 in each time period.

Herein, the preset time interval can be correspondingly set as required. For example, when the ambient light Light1 is sunlight, the time interval can be set correspondingly based on a condition such as weather, season, morning, or evening.

In some embodiments, an adaptive adjustment method is used, and based on a change in the ambient light Light1, an automatic change is made to the steps of obtaining the histogram of the ambient light Light1, adjusting the detection efficiency of the laser beam receiving module 20, adjusting the emission power and/or the number of laser beam emissions of the laser beam emission module 10 in the frame of scanning image, determining the amplitude and the receiving time of the echo signal Light2 based on the current optical signal, and determining the distance information of the to-be-detected object 2 in each time period. That is, the foregoing steps of the ranging adjustment method of the LiDAR device 1 are repeated when it is detected that the ratio or the difference is outside a preset value range.

For example, if the LiDAR device 1 is mounted on a vehicle, when the vehicle enters a tunnel from a tunnel entrance, normal ambient light Light1 or intense ambient light Light1 changes to weak ambient light Light1, at this time, histogram data of the ambient light Light1 in a total optical signal is decreased, which causes a decrease in histogram data of the total optical signal, at this time, a ratio or a difference is decreased, obtained histogram data of an echo signal Light2 is decreased, and as a result, ranging accuracy is decreased; or when the vehicle leaves the tunnel from a tunnel exit, the weak ambient light Light1 changes to the normal ambient light Light1 or the intense ambient light Light1, at this time, histogram data of the ambient light Light1 in a total optical signal is increased, which causes an increase in histogram data of the total optical signal, at this time, a ratio or a difference is increased, obtained histogram data of an echo signal Light2 is increased, and as a result, a ranging error is caused. Therefore, when it is detected that a ratio or a difference changes and exceeds the preset value range, the next ranging adjustment is actively performed to improve the ranging accuracy.

It should be understood that a sequence number of each step in the foregoing embodiments does not mean an execution sequence. An execution sequence of each process should be determined based on a function and internal logic of each process, and should not constitute any limitation to an implementation process of the embodiments of the present disclosure.

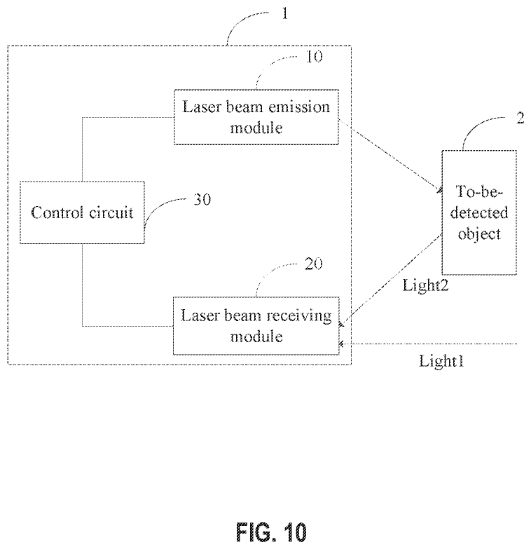

A second aspect of the embodiments of the present disclosure provides a LiDAR device 1. As shown in FIG. 10, the LiDAR device 1 includes a laser beam emission module 10, a laser beam receiving module 20, and a control circuit 30 respectively connected to the laser beam emission module 10 and the laser beam receiving module 20, where the control circuit 30 includes a memory, a processor, and a computer program stored in the memory and capable of running on the processor, where when the processor executes the computer program, steps of the foregoing ranging adjustment method of a LiDAR device 1 are implemented.

In some embodiments, the control circuit 30 correspondingly initiates the ranging adjustment at the preset time interval or based on a calculated ratio or difference, and during each ranging adjustment, the laser beam emission module 10 is first turned off and the laser beam receiving module 20 is turned on, and the laser beam receiving module 20 obtains multiple converted pulse signals. The multiple pulse signals are superimposed and converted into the histogram data of the ambient light Light1 based on a time sequence and amplitude, the detection efficiency of the laser beam receiving module 20 is adjusted based on the histogram data of the ambient light Light1, and the emission power and/or the number of laser beam emissions of the laser beam emission module 10 in one frame of scanning image is adjusted, or emission power and/or a number of laser beam emissions of the laser beam emission module 10 in the next frame of scanning image is correspondingly adjusted based on histogram data of the echo signal Light2 that is determined after ranging in a previous frame is completed.

When the histogram data of the ambient light Light1 is obtained, intensity of the current ambient light Light1 can be determined. When an excessively small electrical signal is converted and output due to oversaturation or an excessively small gain caused by an excessively large gain of the laser beam receiving assembly 21, the control circuit 30 adjusts the detection efficiency of the laser beam emission module 10 based on the intensity of the ambient light Light1. That is, when intense ambient light Light1 is detected, the detection efficiency of the laser beam receiving assembly 21 is reduced, to reduce the sensitivity of the laser beam receiving assembly 21 and avoid oversaturation caused by the excessively large gain of the laser beam receiving assembly 21. In addition, when weak ambient light Light1 is detected, the detection efficiency of the laser beam receiving assembly 21 is improved, to improve the sensitivity and gain of the laser beam receiving assembly 21, thereby ensuring that the laser beam receiving assembly 21 reliably receives the current ambient light Light1 and an echo signal Light2.

In addition, ranging performance of the LiDAR device 1 varies with the detection efficiency, and in order to ensure the ranging performance, the control circuit 30 adjusts the emission power and/or the number of laser beam emissions of the laser beam emission module 10 in the frame of scanning image. The number of laser beam emissions in the frame of scanning image is increased, that is, the number of superimposition times of the histogram data is increased, to improve a signal-to-noise ratio of a signal and improve the ranging capability. The emission power is increased to increase intensity of the echo signal Light2, thereby improving the ranging capability. One of the two methods can be selected or adjustment is performed separately as per a time sequence.

In some embodiments, after the distance information of the to-be-detected object 2 is determined, the emission power and/or the number of laser beam emissions of the laser beam emission module 10 in the frame of scanning image is correspondingly adjusted based on the histogram data of the echo signal Light2. The number of laser beam emissions in the frame of scanning image is increased, that is, the number of superimposition times of the histogram data is increased, to improve a signal-to-noise ratio of a signal and improve the ranging capability. The emission power is increased to increase intensity of the echo signal Light2, thereby improving the ranging capability. One of the two methods can be selected or adjustment is performed separately as per time sequence.

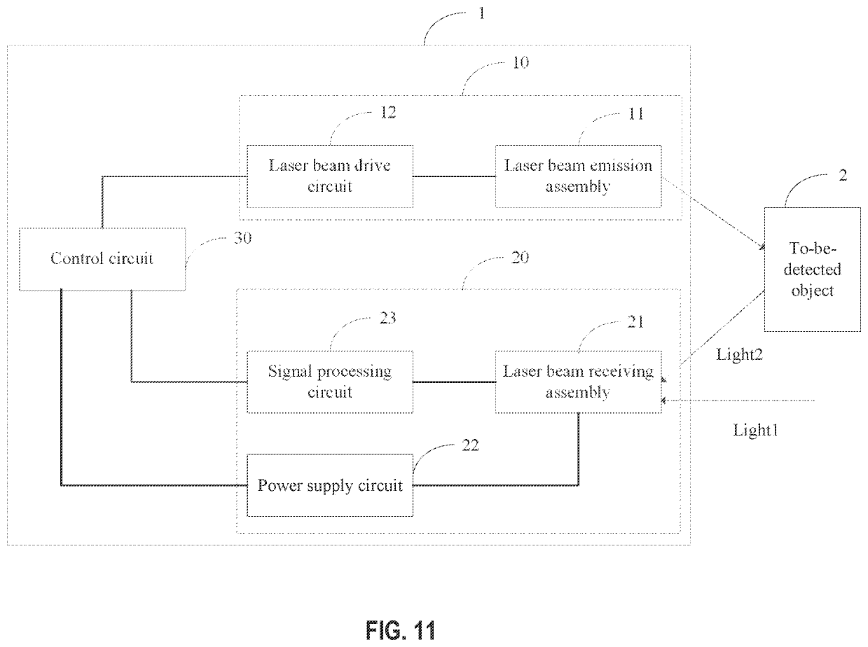

As shown in FIG. 11, in some embodiments, the laser beam emission module 10 includes: a laser beam emission assembly 11; and a laser beam drive circuit 12 respectively connected to the control circuit 30 and the laser beam emission assembly 11, where the laser beam drive circuit 12 is correspondingly turned on or off based on a control signal output by the control circuit 30, and correspondingly adjusts emission power and/or a number of laser beam emissions of the laser beam emission module 10 in one frame of scanning image, where the laser beam emission assembly 11 includes multiple lasers.

In some embodiments, the control circuit 30 controls the laser beam drive circuit 12 to turn off when obtaining the histogram data of the ambient light Light1, and then adjusts emission power and/or a number of laser beam emissions of the laser beam drive circuit 12 in one frame of scanning image when adjusting the detection efficiency of the laser beam receiving module 20. After adjusting the emission power and/or the number of laser beam emissions in the frame of scanning image, the control circuit 30 controls the laser beam drive circuit 12 to start working and drive the laser to work based on the adjusted emission power and/or number of laser beam emissions.

In some embodiments, after adjusting the detection efficiency of the laser beam receiving module 20, the control circuit 30 controls the laser beam drive circuit 12 to start working and drive the laser beam receiving module 20 to work based on the adjusted detection efficiency, and then the control circuit correspondingly adjusts emission power and/or a number of laser beam emissions of the laser in the next frame of scanning image based on the determined histogram data of the echo signal Light2.

Still referring to FIG. 11, in some embodiments, the laser beam receiving module 20 includes:
a laser beam receiving assembly 21, where the laser beam receiving assembly 21 is configured to convert a corresponding optical signal into a current signal; a power supply circuit 22 respectively connected to the control circuit 30 and the laser beam receiving assembly 21, where the power supply circuit 22 is triggered by a control signal of the control circuit 30 to output a voltage signal with a corresponding value to the laser beam receiving assembly 21, to adjust detection efficiency of the laser beam receiving assembly 21; and a signal processing circuit 23 respectively connected to the laser beam receiving assembly 21 and the control circuit 30, where the signal processing circuit 23 is configured to: convert, into corresponding histogram data, an electrical signal converted and output by the laser beam receiving assembly 21, and output the corresponding histogram data to the control circuit 30, where the laser beam receiving assembly 21 includes a photoelectric converter.

When obtaining the histogram data of the ambient light Light1, the control circuit 30 turns on the laser beam receiving assembly 21, the processing circuit, and the power supply circuit 22, the laser beam receiving assembly 21 converts the optical signal to the current signal, and the signal processing circuit 23 converts the current signal to a voltage signal, and outputs multiple pulse signals to the control circuit 30. The control circuit 30 determines the histogram data of the current ambient light Light1, and adjusts an output voltage of the power supply circuit 22, to adjust detection efficiency of the photoelectric converter. Herein, the detection efficiency is in direct proportion to the output voltage. That is, the higher the output voltage, the higher the detection efficiency; or the lower the output voltage, the lower the detection efficiency.

In addition, when receiving the total optical signal, the photoelectric converter and the signal processing circuit 23 sequentially convert the optical signal to the current signal and convert the current signal to the voltage signal, and output multiple pulse signals to the control circuit 30. The control circuit 30 determines histogram data of the total optical signal and determines histogram data, amplitude, and receiving time of the echo signal Light2, to range the to-be-detected object 2.

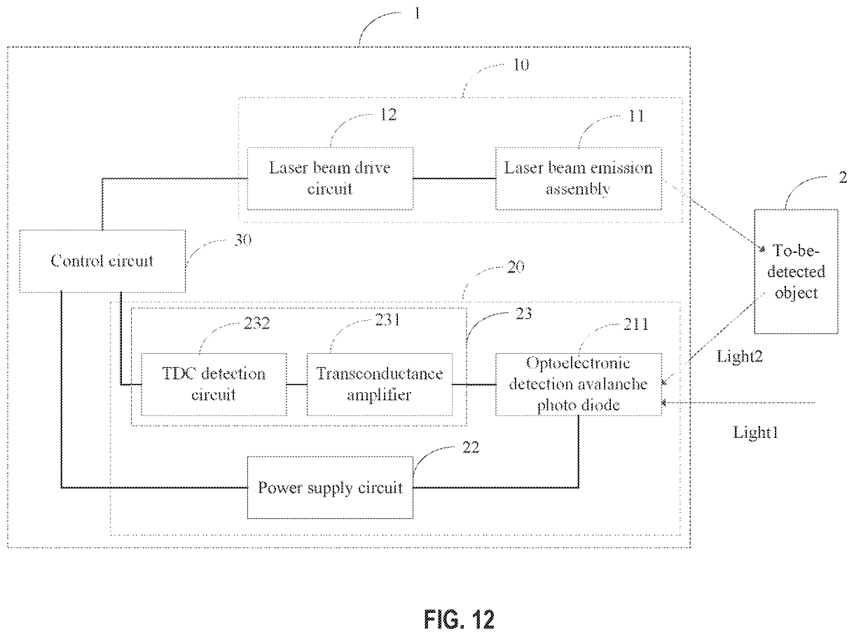

Herein, the photoelectric converter can be a photoelectric converter such as a silicon photomultiplier or a photoelectric detection avalanche diode 211. In some embodiments, as shown in FIG. 12, the photoelectric converter includes a photoelectric detection avalanche diode 211. The photoelectric detection avalanche diode 211 adaptively changes the gain along with intensity of the light. The control circuit 30 adjusts a working voltage of the photoelectric detection avalanche diode 211 based on the obtained histogram data of the ambient light Light1, thereby adjusting the detection efficiency of the photoelectric detection avalanche diode 211 and improving anti-glare and anti-interference capability of the LiDAR device 1.

In some embodiments, as shown in FIG. 12, the signal processing circuit 23 includes:
a transconductance amplifier 231, where the transconductance amplifier 231 is configured to convert a current signal into an analog echo signal Light2 of a voltage type; and
a TDC detection circuit 232, where the TDC detection circuit 232 collects data of the analog echo signal Light2 and outputs multiple pulse signals to a control circuit 30.

Herein, the transconductance sensor is connected to the photoelectric detection avalanche diode 211, and converts, into the voltage signal, the current signal converted and output by the photoelectric detection avalanche diode 211. At the same time, the voltage signal is detected and collected by the TDC detection circuit 232, multiple pulse signals are converted and output to the control circuit 30, and the control circuit 30 obtains corresponding histogram data based on the multiple pulse signals, and then determines the histogram data, the amplitude and the receiving time of the echo signal Light2, thereby ranging the to-be-detected object 2.

The foregoing embodiments are intended to describe the technical solutions of the present disclosure, but not to limit the present disclosure.

What is claimed is:

1. A ranging adjustment method of a LiDAR device, wherein the LiDAR device comprises a laser beam emission module and a laser beam receiving module, the ranging adjustment method comprising:
turning off a laser beam emission module and turning on a laser beam receiving module, to obtain histogram data of ambient light;
adjusting detection efficiency of the laser beam receiving module based on the histogram data of the ambient light;
turning on the laser beam emission module and the laser beam receiving module, to obtain histogram data of a current optical signal; and
comparing the histogram data of the current optical signal with the histogram data of the ambient light, and determining histogram data of an echo signal and distance information of a to-be-detected object, based on a result of the comparison.

2. The ranging adjustment method according to claim 1, wherein the result of the comparison comprises magnitude of a ratio or magnitude of a difference.

3. The ranging adjustment method according to claim 1, further comprising:
adjusting the detection efficiency of the laser beam receiving module based on the histogram data of the ambient light, and accordingly adjusting emission power or a number of laser beam emissions of the laser beam emission module in one frame of a scanning image.

4. The ranging adjustment method according to claim 1, further comprising:
after the distance information of the to-be-detected object is determined, accordingly adjusting emission power or a number of laser beam emissions of the laser beam emission module in one frame of a scanning image based on the histogram data of the echo signal.

5. The ranging adjustment method according to claim 1, wherein obtaining the histogram data of the ambient light comprises:
turning off the laser beam emission module and turning on the laser beam receiving module to receive current ambient light; and
converting the ambient light received multiple times into multiple corresponding pulse signals, and superimposing the multiple corresponding pulse signals to form the histogram data of the ambient light.

6. The ranging adjustment method according to claim 5, wherein converting the ambient light received multiple times into the multiple corresponding pulse signals, and superimposing the multiple corresponding pulse signals to form the histogram data of the ambient light comprises:
performing averaging processing on the multiple pulse signals converted from the ambient light received multiple times, generating multiple pulse signals with equal amplitude, and superimposing the multiple pulse signals to form the histogram data of the ambient light.

7. The ranging adjustment method according to claim 3, wherein adjusting the detection efficiency of the laser beam receiving module based on the histogram data of the ambient light, and adjusting the emission power or the number of laser beam emissions of the laser beam emission module in one frame of the scanning image comprises:
reducing the detection efficiency of the laser beam receiving module, and increasing the emission power or the number of laser beam emissions of the laser beam emission module in the frame of the scanning image, when the histogram data of the ambient light is greater than a first preset threshold of the histogram data.

8. The ranging adjustment method according to claim 3, wherein adjusting the detection efficiency of the laser beam receiving module based on the histogram data of the ambient light, and adjusting the emission power or the number of laser beam emissions of the laser beam emission module in one frame of the scanning image comprises:
increasing the detection efficiency of the laser beam receiving module, and reducing the emission power or the number of laser beam emissions of the laser beam emission module in the frame of the scanning image, when the histogram data of the ambient light is less than a first preset threshold of the histogram data.

9. The ranging adjustment method according to claim 3, wherein adjusting the detection efficiency of the laser beam receiving module based on the histogram data of the ambient light, and adjusting the emission power or the number of laser beam emissions of the laser beam emission module in one frame of the scanning image comprises:
when the histogram data of the ambient light is within a first preset range of the histogram data, setting the detection efficiency of the laser beam receiving module to constant preset detection efficiency, and setting the emission power or the number of laser beam emissions of the laser beam emission module in the frame of the scanning image to constant power or a constant number of emissions.

10. The ranging adjustment method according to claim 4, wherein adjusting the emission power or the number of laser beam emissions of the laser beam emission module in one frame of the scanning image based on the histogram data of the echo signal, comprises at least one of the following:
when the histogram data of the echo signal is greater than a second preset threshold of the histogram data, reducing the emission power or the number of laser beam emissions of the laser beam emission module in the frame of the scanning image;
when the histogram data of the echo signal is less than a second preset threshold of the histogram data, increasing the emission power or the number of laser beam emissions of the laser beam emission module in the frame of the scanning image; or
when the histogram data of the echo signal is within a second preset range of the histogram data, setting the emission power or the number of laser beam emissions of the laser beam emission module in the frame of the scanning image to constant power or a constant number of emissions.

11. A LiDAR device, comprising a laser beam emission module, a laser beam receiving module, and a control circuit respectively connected to the laser beam emission module and the laser beam receiving module, wherein the control circuit comprises a memory, a processor, and a computer program stored in the memory and capable of running on the processor, and wherein when the processor executes the computer program, the following processes are implemented:
turning off the laser beam emission module and turning on the laser beam receiving module, to obtain histogram data of ambient light;
adjusting detection efficiency of the laser beam receiving module based on the histogram data of the ambient light;
turning on the laser beam emission module and the laser beam receiving module, to obtain histogram data of a current optical signal; and
comparing the histogram data of the current optical signal with the histogram data of the ambient light, and determining histogram data of an echo signal and distance information of a to-be-detected object, based on a result of the comparison.

12. The LiDAR device according to claim 11, wherein the laser beam emission module comprises:
a laser beam emission assembly; and
a laser beam drive circuit respectively connected to the control circuit and the laser beam emission assembly, wherein the laser beam drive circuit is accordingly turned on or off based on a control signal output by the control circuit, and accordingly adjusts emission power or a number of laser beam emissions of the laser beam emission module in one frame of a scanning image,
wherein the laser beam emission assembly comprises multiple lasers.

13. The LiDAR device according to claim 11, wherein the laser beam receiving module comprises:
a laser beam receiving assembly, wherein the laser beam receiving assembly is configured to convert a corresponding optical signal into a current signal;
a power supply circuit respectively connected to the control circuit and the laser beam receiving assembly, wherein the power supply circuit is triggered by a control signal of the control circuit to output a voltage signal with a corresponding value to the laser beam receiving assembly, to adjust detection efficiency of the laser beam receiving assembly; and
a signal processing circuit respectively connected to the laser beam receiving assembly and the control circuit, wherein the signal processing circuit is configured to: convert, into corresponding histogram data, an electrical signal converted and output by the laser beam receiving assembly, and output the corresponding histogram data to the control circuit,
wherein the laser beam receiving assembly comprises a photoelectric converter.

14. The LiDAR device according to claim 13, wherein the photoelectric converter comprises a photoelectric detection avalanche diode.
